(19) United States
(12) Patent Application Publication
(10) Pub. No.: US 2020/0055469 A1
(43) Pub. Date: Feb. 20, 2020

(54) PATH REGULATING MEMBER, CLAMP, AND WIRE HARNESS

(71) Applicants: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(72) Inventors: Tomoya KAWAGUCHI, Yokkaichi-shi, Mie (JP); Yuichi KIMOTO, Yokkaichi-shi, Mie (JP)

(73) Assignees: AUTONETWORKS TECHNOLOGIES, LTD., Yokkaichi-shi, Mie (JP); SUMITOMO WIRING SYSTEMS, LTD., Yokkaichi-shi, Mie (JP); SUMITOMO ELECTRIC INDUSTRIES, LTD., Osaka-shi, Osaka (JP)

(21) Appl. No.: 16/497,660

(22) PCT Filed: Mar. 23, 2018
(86) PCT No.: PCT/JP2018/011711

§ 371 Date: Sep. 25, 2019

(30) Foreign Application Priority Data
Mar. 30, 2017 (JP) 2017-067435

(51) Int. Cl. B60R 16/02; H02G 3/32; H02G 3/34; H02G 3/04

(52) U.S. Cl. CPC B60R 16/0215; H02G 3/0468; H02G 3/34; H02G 3/32

(57) ABSTRACT

A path regulating member that is to be used as a constituent member of a wire harness, wherein the wire harness includes a wire, an external cover that is flexible and covers the wire, and a clamp that includes a support that has an annular structure and supports the path regulating member and an attachment that has an annular structure and to which the external cover is attached, the path regulating member including a body that has an axial direction along a path along which the wire is arranged, and is configured to regulate the path of the wire from the outside of the external cover.

### BACKGROUND

The present disclosure relates to a path regulating member, a clamp, and a wire harness.

As disclosed in JP 2011-155763A, a wire harness is known that includes a spine member that regulates a path along which a wire is arranged from the outside of a corrugated tube that protects the wire.

### SUMMARY

As described above, the path of a wire that is protected by a flexible external covering member such as a corrugated tube can be regulated by coupling the external covering member to a path regulating member (spine member). The path regulating member and the external covering member are coupled to each other using a clamp. Here, a support portion of the clamp and the path regulating member that is supported by the support portion sometimes move relative to each other in the axial direction of the path regulating member. Such relative movement accelerates wearing of the support portion, for example, and as a result, the support of the path regulating member by the clamp may become unstable.

An exemplary aspect of the disclosure provides a path regulating member, a clamp, and a wire harness that enable stable support of a path regulating member that regulates the path of an external covering member.

A path regulating member according to an exemplary aspect is a path regulating member that is to be used as a constituent member of a wire harness, wherein the wire harness includes a wire, an cover that is flexible and covers the wire, and a clamp that includes a support that has an annular structure and supports the path regulating member and an attachment that has an annular structure and to which the external cover is attached, the path regulating member includes a body that has an axial direction along a path along which the wire is arranged, and is configured to regulate the path of the wire from the outside of the external cover, wherein the body has a recessed restriction that is configured to be fitted to the annular structure of the support of the clamp and thus restrict relative movement between the body and the support in the axial direction of the body.

According to this configuration, relative movement between the support of the clamp and the path regulating member in the axial direction of the path regulator is restricted.

In the above-described path regulating member, a plurality of the recessed restrictions may be arranged at opposite positions in a radial direction of the body.

The recessed restrictions of the body can be arranged as described above, for example.

In the above-described path regulating member, the recessed restriction may be constituted by a spiral groove that turns around an axis of the body.

The recessed restriction of the body can be configured as described above, for example.

In the above-described path regulating member, a plurality of the recessed restrictions may include a first recessed restriction and a second recessed restriction that is arranged at a position different from that of the first recessed restriction in the axial direction of the body.

According to this configuration, the position of the path regulator to be supported by the support of the clamp can be selected.

A clamp according to an exemplary aspect is a clamp that is to be used as a constituent member of a wire harness, wherein the wire harness includes a wire, an external cover that is flexible and covers the wire, and a path regulator that has an axial direction along a path along which the wire is arranged, and regulates the path of the wire from the outside of the external cover, and the clamp includes a support that has an annular structure and is configured to support the path regulator and an attachment that has an annular structure and to which the external cover is to be attached, and the annular structure of the support is configured to fit in a recessed restriction of the path regulator and thus restrict relative movement between the path regulator and the support in the axial direction of the path regulator.

In the above-described clamp, it is preferable that the annular structure of the attachment includes an insertion that allows for the external coverto be inserted in a radial direction of the annular structure, the clamp includes a communicator through which the annular structure of the attachment and the annular structure of the support communicate with each other, and the clamp is configured such that the path regulator that has been inserted through the insertion passes through the communicator and is supported by the support.

According to this configuration, an intermediate portion of the path regulating member can be supported by the support of the clamp.

In the above-described clamp, it is preferable that the external cover has an annular reciess, and the attachment of the clamp is configured to fit in the annular recess.

According to this configuration, movement of the external cover in the axial direction relative to the attachment of the clamp is suppressed. Therefore, the path of the external cover can be favorably regulated by the path regulator that is supported by the support of the clamp.

A wire harness according to an exemplary aspect includes a wire, an external cover that is flexible and covers the wire, a path regulator that has an axial direction along a path along which the wire is arranged, and regulates the path of the wire from the outside of the external cover, and a clamp that includes a support that has an annular structure and supports the path regulator and an attachment that has an annular structure and to which the external cover is attached, wherein the path regulator has a recessed restriction that is fitted to the annular structure of the support and thus restricts relative movement between the path regulator and the support in the axial direction of the path regulator.

According to the present disclosure, a path regulator that regulates the path of an external cover can be stably supported.

### BRIEF DESCRIPTION OF THE DRAWINGS

FIG. 1 is a schematic plan view showing a wire harness of an embodiment.

FIG. 2 is a schematic diagram showing an arrangement of the wire harness in a vehicle.

FIG. 3 is an exploded perspective view showing a portion of the wire harness.

FIG. 4 is a partial perspective view showing the wire harness.

FIG. 5 is a partial cross-sectional view showing a variation of the wire harness.

FIG. 6(a) is a plan view showing a variation of the wire harness and FIG. 6(b) is a front view showing a variation of a clamp.

### DETAILED DESCRIPTION OF EMBODIMENTS

The following describes embodiments of a path regulating member, a clamp, and a wire harness.

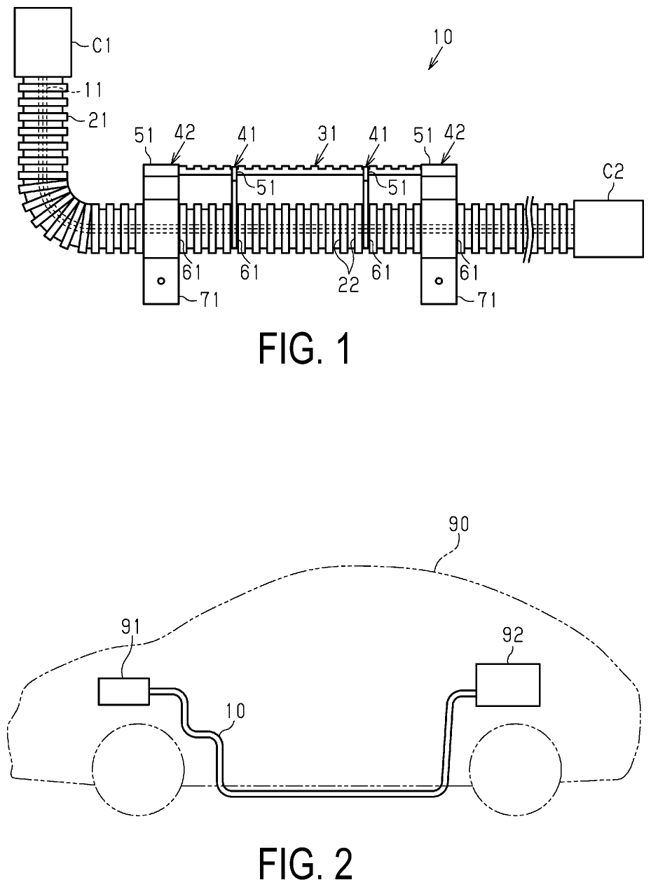

As shown in FIG. 1, a wire harness 10 includes a wire 11, an external covering member 21 (external cover) that is flexible and covers the wire 11, a path regulating member 31 that regulates a path along which the wire 11 is arranged from the outside of the external covering member 21, an intermediate portion clamp 41 that supports an intermediate portion of the path regulating member 31, and an end portion clamp 42 that supports an end portion of the path regulating member 31.

### Arrangement

As shown in FIG. 2, the wire harness 10 is used to electrically connect a first apparatus 91 and a second apparatus 92 to each other that are installed in a vehicle 90. The first apparatus 91 is arranged on the front side of the vehicle 90. The second apparatus 92 is arranged on the rear side of the vehicle 90. For example, one of the first apparatus 91 and the second apparatus 92 is a battery and the other is an inverter. It should be noted that one of the first apparatus 91 and the second apparatus 92 may also be a motor and the other may also be an inverter. Examples of the vehicle 90 include an electric automobile, a hybrid automobile, a fuel-cell automobile, and the like. The wire harness 10 of this embodiment is arranged under the floor of the vehicle 90.

### Wire 11

The wire 11 includes a conductive core wire and an insulating covering. The core wire is made of a conductive material such as copper or aluminum, for example. The core wire is constituted by a single strand or a plurality of strands. The insulating covering is made of an insulating material such as polyvinyl chloride and has a tubular shape as is well known.

As shown in FIG. 1, opposite end portions of the wire 11 are respectively constituted by connector portions C1 and C2. The wire 11 is a high-voltage wire and is electrically connected to input/output terminals of the first apparatus 91 and the second apparatus 92 installed in the vehicle 90. The rated voltage of high-voltage wires for vehicles exceeds 30 V in the case of an alternating current and exceeds 60 V in the case of a direct current. It should be noted that the rated voltage of high-voltage wires for vehicles is no greater than 600 V in the case of an alternating current and no greater than 750 V in the case of a direct current.

The wire 11 may include a shield member that serves as a shield against electromagnetic waves, or a shield member against electromagnetic waves may be separately provided on the outer periphery of the wire 11. For example, a braided member that has a mesh structure obtained by braiding metallic threads made of aluminum, stainless steel, copper, an alloy of any of these metals, or the like can be favorably used as the shield member.

### External Covering Member 21

The external covering member 21 is flexible and therefore can deform so as to conform to the wiring path of the wire 11. The external covering member 21 protects the wire 11 by covering the wire 11. The external covering member 21 has a tubular shape having a longitudinal direction, and the wire 11 is arranged in the interior space of the external covering member 21. The external covering member 21 is preferably made of a resin material from the viewpoint of weight reduction, for example. Examples of resin materials include polyolefin, polyamide, polyester, an ABS resin, and the like. Specific examples of the external covering member 21 include a corrugated tube, a hard resin pipe, and the like.

The external covering member 21 in this embodiment is a corrugated tube and can easily curve or bend as a result of having a structure in which a plurality of annular recessed portions 22 being arranged in the longitudinal direction.

The external covering member 21 may have a slit that extends in the longitudinal direction. If the external covering member 21 has a slit, the wire 11 can be arranged inside the external covering member 21 by passing through the slit. It should be noted that, if the external covering member 21 has a slit, the wire 11 can be kept from coming out of the slit by winding a binding member such as adhesive tape around the outer periphery of the external covering member 21 as necessary.

### Path Regulating Member 31

The path regulating member 31 has an axial direction along the path along which the wire 11 is arranged. The path regulating member 31 is arranged so as to partially regulate the path of the wire 11 from the outside of the external covering member 21. The wire harness 10 may include a single path regulating member 31 (path regulator) or a plurality of path regulating members 31. That is, a plurality of sections of the wire 11 of the wire harness 10 may be regulated by a plurality of path regulating members 31 or one section of the wire 11 may be regulated by a single path regulating member 31. A configuration is also possible in which the path regulating member 31 only has a straight portion, or has a curved portion.

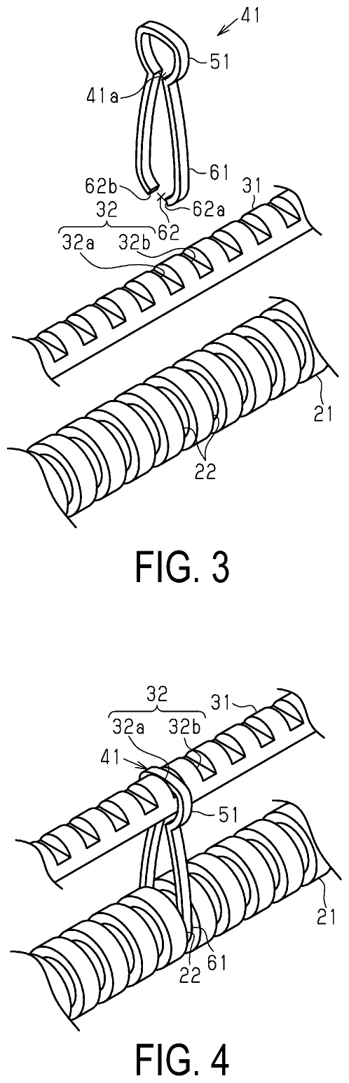

As shown in FIG. 3, the path regulating member 31 has a plurality of recessed restriction portions 32 (recessed restrictions) that restrict relative movement, which will be described later. The recessed restriction portions 32 include a first recessed restriction portion 32a and a second recessed restriction portion 32b that is arranged at a position different from that of the first recessed restriction portion 32a in the axial direction of the path regulating member 31. The path regulating member 31 can be formed through, for example, cutting processing for cutting a bar-shaped member to a predetermined length, pressing processing for plastically deforming the outer peripheral shape, machining processing for machining the outer peripheral surface, bending processing for deforming the path regulating member so as to conform to the wiring path of the wire 11, and the like. The path regulating member 31 can also be molded in a mold.

The path regulating member 31 is made of a material that has sufficient rigidity to maintain the path of the wire 11 arranged inside the external covering member 21. The path regulating member 31 is preferably made of a plastically deformable material from the viewpoint of enabling setting of the path through bending processing. Metallic materials are preferably used as the material of the path regulating member 31. Examples of metallic materials include aluminum, iron, copper, alloys of any of these metals, and the like. It should be noted that the path regulating member 31 may have a tubular shape.

### Intermediate Portion Clamp 41 and End Portion Clamp 42

As shown in FIG. 1, the intermediate portion clamp 41 and the end portion clamp 42 each have a support portion 51 (support) that supports the path regulating member 31 and an attachment portion 61 (attachment) to which the external covering member 21 is attached. The end portion clamp 42 further has a fixing portion 71 to be fixed to the vehicle 90.

First, the relationship between the support portion 51 of the intermediate portion clamp 41 and the path regulating member 31 will be described.

As shown in FIGS. 3 and 4, the support portion 51 of the intermediate portion clamp 41 that supports the path regulating member 31 has an annular structure. As a result of the annular structure of the support portion 51 fitting in the recessed restriction portion 32 of the path regulating member 31, relative movement between the support portion 51 and the path regulating member 31 in the axial direction of the path regulating member 31 is restricted.

In other words, as a result of the recessed restriction portion 32 of the path regulating member 31, which is supported by the support portion 51 of the intermediate portion clamp 41, being fitted to the annular structure of the support portion 51, relative movement between the path regulating member 31 and the support portion in the axial direction of the path regulating member 31 is restricted.

Next, the attachment portion 61 of the intermediate portion clamp 41 will be described.

The attachment portion 61 of the intermediate portion clamp 41 has an annular structure. The annular structure of the attachment portion 61 includes an insertion portion 62 that allows for the external covering member 21 to be inserted in a radial direction of the annular structure. That is, the annular structure of the attachment portion 61 is a noncontinuous annular structure and includes a first end portion 62a and a second end portion 62b that is spaced apart from the first end portion 62a. The annular structure of the attachment portion 61 is configured to be deformable between an insertion posture that allows for the external covering member 21 to be inserted through the insertion portion 62 between the first end portion 62a and the second end portion 62b and an attachment posture that the annular structure takes when the external covering member 21 has been attached. That is, the annular structure of the attachment portion 61 can be elastically deformed so as to enlarge the space between the first end portion 62a and the second end portion 62b (the width of the insertion portion 62). It should be noted that the attachment portion 61 may be configured such that the first end portion 62a and the second end portion 62b come into contact with each other when the attachment portion takes the attachment posture with the external covering member 21 attached thereto.

Next, the relationship between the support portion 51 and the attachment portion 61 of the intermediate portion clamp 41 will be described.

The intermediate portion clamp 41 has a communication portion 41a (communicator) through which the annular structure of the attachment portion 61 and the annular structure of the support portion 51 communicate with each other. The intermediate portion clamp 41 is configured such that the path regulating member 31 that has been inserted through the insertion portion 62 of the attachment portion 61 passes through the communication portion 41a and is supported by the support portion 51. That is, the annular structure of the attachment portion 61 can deform into an insertion posture that allows for the path regulating member 31 to be inserted through the insertion portion 62 between the first end portion 62a and the second end portion 62b. Also, the communication portion 41a of the intermediate portion clamp 41 can deform between an enlarged posture that allows for the path regulating member 31 to pass therethrough and a support posture that the communication portion takes when supporting the path regulating member 31.

Next, the relationship between the attachment portion 61 of the intermediate portion clamp 41 and the external covering member 21 will be described.

The attachment portion 61 of the intermediate portion clamp 41 is configured to have dimensions that are set such that the attachment portion 61 fits in the annular recessed portion 22 of the external covering member 21. Since the plurality of annular recessed portions 22 of the external covering member 21 are arranged in the longitudinal direction of the external covering member 21, the position of the external covering member 21 that is to be attached to the attachment portion 61 can be selected. It should be noted that the dimensions of the attachment portion 61 can be changed according to dimensions of the annular recessed portion 22 of the external covering member 21. Also, the annular structure of the attachment portion 61 may be changed to a configuration that includes a plurality of protrusions so that the protrusions fit in a plurality of annular recessed portions 22 of the external covering member 21.

Next, the end portion clamp 42 will be described.

In the end portion clamp 42 shown in FIG. 1, well-known configurations that can exhibit functions of the support portion 51 and the attachment portion 61 can be employed as the configuration of the support portion 51 that supports the path regulating member 31 and the configuration of the attachment portion 61 to which the external covering member 21 is attached. The support portion 51 of the end portion clamp 42 preferably has the shape of a cap that includes a wall portion on which an end face of the path regulating member 31 abuts.

The end portion clamp 42 further has the fixing portion 71 to be fixed to the vehicle 90. The fixing portion 71 has a through hole for inserting a bolt therethrough. The end portion clamp 42 can be fixed to the vehicle 90 using a bolt and a nut. The bolt may be welded to the vehicle 90 in advance. It should be noted that the fixing portion 71 of the end portion clamp 42 may be a clip that locks in an attachment hole provided in the vehicle 90, for example.

The intermediate portion clamp 41 and the end portion clamp 42 can be made of metallic materials or resin materials. The intermediate portion clamp 41 and the end portion clamp 42 are preferably made of resin materials from the viewpoint of weight reduction, for example. Examples of resin materials include polyolefin, polyamide, polyester, an ABS resin, and the like.

### Manufacturing Method

Next, one example of manufacturing methods of the wire harness 10 will be described.

In order to manufacture the wire harness 10, the path regulating member 31 is supported by the respective support portions 51 of the intermediate portion clamp 41 and the end portion clamp 42 and the external covering member 21 is attached to the respective attachment portions 61 of the intermediate portion clamp 41 and the end portion clamp 42.

As shown in FIGS. 3 and 4, in order to support the path regulating member 31 with the support portion 51 of the intermediate portion clamp 41, first, the path regulating member 31 is inserted through the insertion portion 62 in the attachment portion 61 of the intermediate portion clamp 41. Next, the path regulating member 31 is passed through the communication portion 41a of the intermediate portion clamp 41 and is supported by the support portion 51. At this time, the annular structure of the support portion 51 of the intermediate portion clamp 41 is fitted in the recessed restriction portion 32 of the path regulating member 31.

Next, the external covering member 21 is attached to the attachment portion 61 of the intermediate portion clamp 41. It should be noted that the wire 11 may be arranged inside the external covering member 21 before or after the external covering member 21 is attached to the respective attachment portions 61 of the intermediate portion clamp 41 and the end portion clamp 42.

The thus obtained wire harness 10 preferably includes at least one pair of end portion clamps 42 that support both end portions of the path regulating member 31 and an intermediate portion clamp 41 between the pair of end portion clamps 42. It should be noted that the path regulating member 31 can also be fixed to the vehicle 90 using a clamp other than the end portion clamp 42.

Next, functions and effects of this embodiment will be described.

(1) The path regulating member 31 has the recessed restriction portion 32 that fits to the annular structure of the support portion 51 of the intermediate portion clamp 41 and thus restricts relative movement between the path regulating member 31 and the support portion 51 in the axial direction of the path regulating member 31.

According to this configuration, relative movement between the support portion 51 of the intermediate portion clamp 41 and the path regulating member 31 in the axial direction of the path regulating member 31 is restricted, and therefore the path regulating member 31 that regulates the path of the external covering member 21 can be stably supported.

(2) The recessed restriction portions 32 of the path regulating member 31 include the first recessed restriction portion 32a and the second recessed restriction portion 32b that is arranged at a position different from that of the first recessed restriction portion 32a in the axial direction of the path regulating member 31.

In this case, the position of the path regulating member 31 to be supported by the support portion 51 of the intermediate portion clamp 41 can be selected. Therefore, versatility of the path regulating member 31 can be enhanced. That is, the path regulating member can be applied to wire harnesses 10 that have different designs.

(3) The annular structure of the support portion 51 of the intermediate portion clamp 41 is configured to fit in the recessed restriction portion 32 of the path regulating member 31 and thus restrict relative movement between the path regulating member 31 and the support portion 51 in the axial direction of the path regulating member 31.

According to this configuration, the same functions and effects as those described in the above section (1) can be achieved.

(4) The annular structure of the attachment portion 61 of the intermediate portion clamp 41 includes the insertion portion 62 that allows for the external covering member 21 to be inserted in the radial direction of the annular structure. The intermediate portion clamp 41 has the communication portion 41a through which the annular structure of the attachment portion 61 and the annular structure of the support portion 51 communicate with each other. The intermediate portion clamp 41 is configured such that the path regulating member 31 that has been inserted through the insertion portion 62 passes through the communication portion 41a and is supported by the support portion 51.

In this case, an intermediate portion of the path regulating member 31 can be supported by the support portion 51 of the intermediate portion clamp 41. Therefore, for example, even a path regulating member 31 that is relatively long can be smoothly supported by the intermediate portion clamp 41. Furthermore, the intermediate portion clamp 41 can be easily added to a portion that needs to be supported in the intermediate portion of the path regulating member 31, for example. This can increase freedom of design of the wire harness 10.

(5) The external covering member 21 has the annular recessed portion 22. The attachment portion 61 of the intermediate portion clamp 41 is configured to fit in the annular recessed portion 22 of the external covering member 21.

In this case, movement of the external covering member 21 in the axial direction relative to the attachment portion 61 of the intermediate portion clamp 41 is suppressed. Therefore, the path of the external covering member 21 can be favorably regulated by the path regulating member 31 that is supported by the support portion 51 of the intermediate portion clamp 41.

The above embodiments may also be changed as follows.

The number of recessed restriction portions 32 of the path regulating member 31 is not limited to two or more and may also be one.

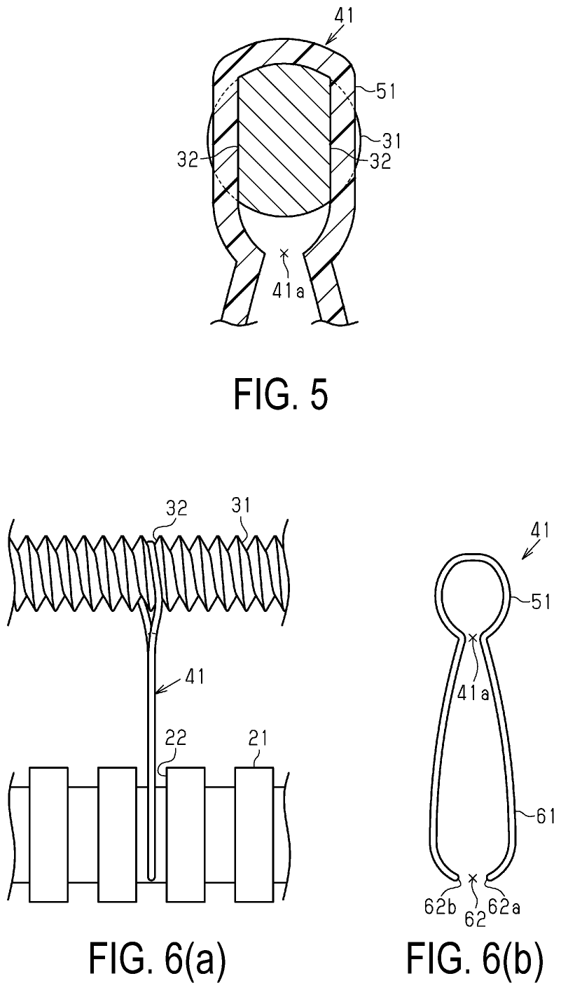

As shown in FIG. 5, recessed restriction portions 32 of the path regulating member 31 can also be arranged at opposite positions in a radial direction of the path regulating member 31.

As shown in FIGS. 6(a) and 6(b), the recessed restriction portion 32 of the path regulating member 31 can also be constituted by a spiral groove that turns around the axis of the path regulating member 31. Further, the intermediate portion clamp 41 may also be constituted by a metallic wire. In this case, although illustration is omitted, the first end portion 62a and the second end portion 62b of the attachment portion 61 of the intermediate portion clamp 41 may also be twisted together to be locked.

The shape of the attachment portion 61 of the intermediate portion clamp 41 can also be changed to a shape that does not fit in the annular recessed portion 22 of the external covering member 21.

The communication portion 41a of the intermediate portion clamp 41 may also be omitted to make the annular structure of the support portion 51 and the annular structure of the attachment portion 61 independent of each other. In this case, the support portion 51 of the intermediate portion clamp 41 can also be changed to a support portion that has an insertion portion for inserting the path regulating member 31 in a radial direction of the annular structure.

The configuration of the support portion 51 of the above-described intermediate portion clamp 41 can also be applied to the support portion 51 of the end portion clamp 42. Also, the configuration of the attachment portion 61 of the above-described intermediate portion clamp 41 can also be applied to the attachment portion 61 of the end portion clamp 42.

The wire 11 of the wire harness 10 may also be a low-voltage wire, and positions that are electrically connected by the wire harness 10 can also be changed as appropriate.

Constituent elements in the above-described embodiments and variations thereof may also be combined.

The external covering member 21 in the embodiment is one example of a flexible protection tube. The path regulating member 31 in the embodiment is one example of an elongated guide for positioning the external covering member 21 to a preset wiring path. The recessed restriction portion 32 of the path regulating member 31 is one example of at least one step portion. The clamp 41 in the embodiment can be configured as a flexible protection tube hanger that is attached to the elongated guide (31) and supports the flexible protection tube (21) in a hanging manner. In some implementation examples, the clamp 41 can be configured as a one-piece component.

The support portion 51 in the embodiment can be configured as a guide grip portion that is in direct contact with the outer surface of the elongated guide (31). In some implementation examples, the support portion 51 is configured as a head portion that has the shape of a narrow band and applies a downward load based on the weight of the clamp 41 to at least an upper portion of the elongated guide (31). In some implementation examples, the head portion (51) having the shape of a narrow band can have an elastic arch portion or an elastic loop portion that is configured to press the elongated guide (31) downward or bind the elongated guide in the horizontal direction.

In some implementation examples, the elongated guide (31) includes at least one step portion (32) for positioning the support portion 51 (especially, the head portion having the shape of a narrow band) relative to the elongated guide (31). The at least one step portion (32) is a recessed portion or a groove that extends in a direction crossing with or orthogonal to the longitudinal axis of the elongated guide (31) and is configured to accommodate at least a portion of the head portion (51) having the shape of a narrow band. In some implementation examples, the at least one step portion (32) includes a plurality of step portions (32) that are provided in an upper portion of the elongated guide (31) so as to be spaced apart from each other in the axial direction of the elongated guide (31). In some implementation examples, the at least one step portion (32) is configured as a pair of recessed portions that are provided on opposite intermediate side surfaces of the elongated guide (31) other than the upper portion and lower portion thereof. In some implementation examples, the at least one step portion (32) is configured as a spiral groove that is formed on the elongated guide (31).

The attachment portion 61 in the embodiment may be called a flexible protection tube holder that limits the maximum separation distance between the flexible protection tube (21) and the elongated guide (31) in a radial direction orthogonal to the axial direction of the flexible protection tube (21) and limits the maximum movable distance of the flexible protection tube (21) relative to the elongated guide (31) in the axial direction of the flexible protection tube (21). In some implementation examples, the flexible protection tube holder (61) includes a plurality of elastic leg portions that elastically sandwich the flexible protection tube (21) in the horizontal direction and support the flexible protection tube (21) from below.

It will be apparent to those skilled in the art that the present disclosure may be embodied in other specific forms without departing from the technical concept of the disclosure. For example, some of the components described in the embodiments (or one or more aspects thereof) may be omitted and/or combined.

1. A path regulating member that is to be used as a constituent member of a wire harness,
wherein the wire harness includes a wire, an external cover that is flexible and covers the wire, and a clamp that includes a support that has an annular structure and supports the path regulating member and an attachment that has an annular structure and to which the external cover is attached, the path regulating member comprising:
a body that has an axial direction along a path along which the wire is arranged, and is configured to regulate the path of the wire from the outside of the external cover, wherein:
the body has a recessed restriction that is configured to be fitted to the annular structure of the support of the clamp and thus restrict relative movement between the body and the support in the axial direction of the body,
the support and the attachment of the clamp are spaced apart from each other in a direction that crosses the axial direction of the body, and
the body is configured to be spaced apart from the external cover in the direction crossing the axial direction when the external cover is attached to the attachment of the clamp and the support of the clamp is fitted in the recessed restriction of the body.

2. The path regulating member according to claim 1,
wherein the recessed restriction includes a plurality of the recessed restrictions that are arranged at opposite positions in a radial direction of the body.

3. The path regulating member according to claim 1,
wherein the recessed restriction is formed by a spiral groove that turns around an axis of the body.

4. The path regulating member according to claim 1,
wherein the recessed restriction includes a plurality of the recessed restrictions that include a first recessed restriction and a second recessed restriction that is arranged at a position different from that of the first recessed restriction in the axial direction of the body.

5. A clamp that is to be used as a constituent member of a wire harness,
wherein the wire harness includes a wire, an external cover that is flexible and covers the wire, and a path regulator that has an axial direction along a path along which the wire is arranged, and regulates the path of the wire from the outside of the external cover, the clamp comprising:
a support that has an annular structure and is configured to support the path regulator; and
an attachment that has an annular structure and to which the external cover-is to be attached, the annular structure of the support being configured to fit in a recessed restriction of the path regulator and thus restrict relative movement between the path regulator and the support in the axial direction of the path regulator,
wherein the support and the attachment of the clamp are spaced apart from each other in a direction that crosses the axial direction of the path regulator, and the clamp is configured to position the path regulator and the external cover-so as to be spaced apart from each other in the direction crossing the axial direction when the external cover is attached to the attachment of the clamp and the support of the clamp is fitted in the recessed restriction of the path regulator.

6. The clamp according to claim 5,
wherein the annular structure of the attachment includes an insertion that allows for the external cover-to be inserted in a radial direction of the annular structure,
the clamp includes a communicator through which the annular structure of the attachment and the annular structure of the support communicate with each other, and
the clamp is configured such that the path regulator that has been inserted through the insertion passes through the communicator and is supported by the support.

7. The clamp according to claim 5,
wherein the external cover-has an annular recess, and the attachment of the clamp is configured to fit in the annular recess.

8. The clamp according to claim
wherein the clamp is configured to be attached to an outer surface of the path regulator and an outer surface of the external cover, and to support the external cover-so as to hang from the path regulator.

9. The clamp according to claim 5,
wherein the support of the clamp is configured as a head that has the shape of a narrow band and fits in the recessed restriction of the path regulator.

10. The clamp according to claim 5,
wherein the attachment of the clamp includes a plurality of elastic legs that support the external cover-from below.

11. A wire harness comprising:
a wire;
an external cover-that is flexible and covers the wire;
a path regulator that has an axial direction along a path along which the wire is arranged, and regulates the path of the wire from the outside of the external cover; and
a clamp that includes a support that has an annular structure and supports the path regulator and an attachment that has an annular structure and to which the external cover-is attached,
wherein the path regulator has a recessed restriction that is fitted to the annular structure of the support and thus restricts relative movement between the path regulator and the support in the axial direction of the path regulator, and
the support and the attachment of the clamp are spaced apart from each other in a direction that crosses the axial direction of the path regulator, and the clamp is configured to position the path regulator and the external cover-so as to be spaced apart from each other in the direction crossing the axial direction when the external cover-is attached to the attachment of the clamp and the support of the clamp is fitted in the recessed restriction of the path regulator.
